(19) United States
(12) Patent Application Publication
(10) Pub. No.: US 2022/0232859 A1
(43) Pub. Date: Jul. 28, 2022

(54) BEVERAGE DISPENSING APPARATUS AND METHODS FOR PREPARING BEVERAGES

(71) Applicant: GOOD DESIGN, INC., Vancouver (CA)

(72) Inventor: Angus RITTENBURG, Perkasie, PA (US)

(21) Appl. No.: 17/597,750

(22) PCT Filed: Jul. 22, 2020
(86) PCT No.: PCT/US2020/043034

§ 371 Date: Jan. 21, 2022

Related U.S. Application Data
(60) Provisional application No. 62/876,965, filed on Jul. 22, 2019.

(51) Int. Cl. A23L 2/54; A23L 2/56

(52) U.S. Cl. CPC A23L 2/54; A23L 2/56

(57) ABSTRACT

A means for adding flavoring and/or ingredients that are not water-soluble into a liquid is disclosed. A means for adding flavoring and/or ingredients that are not completely soluble into a water containing liquid such as a liquid containing alcohol and water (including distilled spirits such as whiskey, rum, gin and vodka as well as ready to drink mixtures thereof), is also disclosed. A means for generating a flavored and/or effervescent beverage with non-water-soluble ingredients using a refillable or replaceable cartridge and a refillable or replaceable container, is also disclosed.

### CROSS REFERENCE TO RELATED PATENT APPLICATIONS

The subject matter of the instant invention is related to U.S. Provisional Patent Application No. 62/876,972, filed Jul. 22, 2019, and entitled “CARTRIDGE FOR DISPENSING PRODUCTS AND METHODS FOR THEIR MANUFACTURE”; the disclosure of which is hereby incorporated by reference.

### FIELD OF THE INVENTION

The present invention is directed to the field of apparatus and methods for preparing and dispensing beverages.

### BACKGROUND OF THE INVENTION

Pre-mixed and canned or bottled beverages must have ingredients that will not separate over time. Ingredients for beverages that are not miscible with water must be converted into emulsions that will not coalesce during the shelf life of the product. A common method for making these emulsions requires ultrasonic mixing of the non-miscible ingredient, surfactant, and water.

This pre-mixed beverage arrangement has several shortcomings. For example, sonication of ingredients is an added process that can increase the cost of manufacturing. The surfactants used to make such emulsions stable often bring their own flavors that are not desirable and must be masked with product flavoring. The masking flavors cost additional money and require additional steps during processing. In some cases, the masking flavors make it impossible to achieve a desired flavor profile. In addition, the relative quantities of ingredients are at the discretion of the manufacturer, not the customer.

Typical beverage arrangements require a consumer to acquire a container filled with liquid and transport it to the location they eventually consume it. The shortcoming to this arrangement is that packaged liquids have considerable density and weight and can take up a lot of space. For example, to carry enough beverages for a consumer to use throughout the day requires one to wield several cans or bottle. However, the basis of most beverages is water, with a small amount of flavoring added. Water is available in most places already. There is a need in the art for a portable solution that allows one to use the water that is already available at their location and add the flavoring to create their beverage in a convenient manner

### SUMMARY OF THE INVENTION

The instant invention solves problems associated with conventional apparatus and methods by providing an apparatus that can combine the contents of a pressurized gas cartridge with a liquid. One embodiment of the present invention relates to an apparatus for mixing a fluidizable material with a liquid, the apparatus comprising a pressurized cartridge having a housing that contains material to be fluidized and introduced into the liquid; wherein the cartridge and the housing are positioned to force the contents from the housing into the liquid.

One embodiment of the invention relates to the foregoing embodiment wherein the fluidizable material comprises an extract.

One embodiment of the invention relates to any combination of the foregoing embodiments wherein the housing defines an orifice that controls the flow of the extract into the liquid.

One embodiment of the invention relates to any combination of the foregoing embodiments wherein the apparatus further comprises an adapter for receiving the housing.

One embodiment of the invention relates to any combination of the foregoing embodiments and further comprising at least one means that adjusts the flow of extract into the liquid.

One embodiment of the invention relates to any combination of the foregoing embodiments wherein the pressurized cartridge comprises at least one of carbon dioxide and nitrogen.

One embodiment of the invention relates to any combination of the foregoing embodiments wherein the cartridge and housing are removably connected to the container.

One embodiment of the invention relates to any combination of the foregoing embodiments and wherein the fluidized material comprises at least one extract.

One embodiment of the invention relates to any combination of the foregoing embodiments and further comprising at least one means that adjusts the flow of extract into the liquid.

One embodiment of the invention relates to any combination of the foregoing embodiments wherein the pressurized material comprises at least one of carbon dioxide and nitrogen.

A further embodiment of the invention relates to a method for dispensing a beverage using any combination of the foregoing apparatus.

One embodiment of the invention relates to the foregoing method wherein the fluidized material is mixed with the liquid before dispensing the beverage.

One embodiment of the invention relates to combining degassed oils to degassed liquids to create a stable emulsion without surfactants.

The various embodiments of the invention can be used alone or in combinations with each other.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is an isometric perspective of the container and cartridge separated.

FIG. 2 is an isometric perspective of the container with the cartridge installed.

FIG. 3 is a cross section of the container FIG. 2.

FIG. 4 is a cross section of the container FIG. 2 in two different configurations.

FIG. 5 is a detail view of cross section EE of FIG. 4.

FIG. 6 is a detail view of cross section FF of FIG. 4.

FIG. 7 is a front view of a mechanism in the container for receiving the cartridge.

Wherever possible, the same reference numbers will be used throughout the drawings to represent the same parts.

### DETAILED DESCRIPTION OF THE INVENTION

This invention provides a means for adding flavoring and/or ingredients that are not water-soluble into a liquid. The invention also provides a means for adding flavoring and/or ingredients that are not completely soluble into a water containing liquid such as a liquid containing alcohol and water (including distilled spirits such as whiskey, rum, gin and vodka as well as ready to drink mixtures thereof). In addition, this invention provides a means for adding flavoring to water to make a flavored beverage. In this way, a consumer can carry portable cartridges and a refillable container and use water from the location of consumption instead of carrying burdensome prepacked beverages with them. This invention is novel in that it provides a means for generating a flavored beverage with non-water-soluble ingredients using a refillable or replaceable cartridge and a refillable or replaceable container. Unlike existing apparatus, the entire device is portable and can be refilled anywhere. The device includes a cartridge, a dispensing system, a liquid to be prepared, and a cartridge containing gas, flavor, and other ingredients (which can be soluble and non-water-soluble). The cartridge can be made to comply with the filling requirements of 49 CFR 173.304 (2016) as well as the shipment requirements of 49 CFR 173.301 (2002); hereby incorporated by reference.

Plant extracts are one example of non-water-soluble ingredients that are often mixed into beverages. Extracts will be referred to throughout this disclosure. It is to be understood that extract can include, without limitation, any botanical or other plant-based ingredient that is to be mixed into a liquid.

This invention also provides a means for mixing the contents of the cartridge with the beverage. The flavors and extracts stored in the gas cartridge can be injected into the beverage by opening a valve in the cartridge, causing the pressurized gas to push the contents into the liquid in a high velocity stream which encourages mixing. In this way, a user can simply fill the bottle with water and add flavor and extract by inserting a cartridge. While any suitable cartridge can be employed, one example of a suitable cartridge is disclosed in the previously identified and related patent application entitled “CARTRIDGE FOR DISPENSING PRODUCTS AND METHODS FOR THEIR MANUFACTURE”.

The invention further provides a method for adding flavor and extracts to a beverage and a method for dispensing the foregoing into liquid in the bottle without creating effervescence. This can be achieved by using a gas that does not dissolve in the liquid. While any suitable gas can be employed, in one example, nitrogen could be used for delivering the flavor/extracts to a water-based beverage. The liquid will not be made as effervescent because the gas is not as soluble in the liquid. In this case, the gas is useful for pushing the flavor and extracts from a pressurized cartridge into the beverages in a turbulent manner favorable for homogeneous mixing. The gas also adds pressure which can be used to force the liquid out of the bottle for dispensing.

The invention further provides a method for emptying a gas cartridge with any phase of gas as well as flavor and extracts into a liquid. As one example, the gas cartridge could be filled with a combination of liquified CO₂, fruit flavor, and CBD oil extracts and emptied into a water solution to create a fruit flavored CBD beverage. In a particular application, 3 grams of hemp extract could be put in a cartridge containing 2 ml of CO₂ gas at 100 psi. The cartridge could be used to add hemp extract to 1 liter of beverage liquid using the inventive apparatus. The inventive apparatus could then be used to dispense a hemp infused beverage.

The invention further provides a means for masking unfavorable flavors using gasses that change the nature of the liquid. As one example, Nitrogen is known to change the “mouthfeel” of beverages in a way that can change the way that flavors are perceived.

The invention also provides a means for putting an inventive dispenser and cartridge into existing bottles by way of either a direct connection or an adapter or a coupler including via snap-fit and threaded connections (e.g., the dispenser is removably connected to the existing bottle and can be reused with another bottle). As just one example, an inventive dispenser and cartridge could be used to add flavor and extracts to liquid by installing it on a common 2 L soda bottle. The dispenser could have a standard bottle threads such as PCO1810 or PCO1881; hereby incorporated by reference.

The invention also provides a means to keep degassed ingredients in a cartridge and degassed liquid in a separate container. The cartridge could combine the degassed ingredients and the degassed liquid at the time of consumption. An advantage to this method is that ingredients that are not miscible in the liquid (such as essential oils) could be mixed (generally homogenously) in the liquid and stable for several hours. Without such an invention, one would have to create an emulsification using surfactants to create a stable oil in liquid emulsion. Surfactants are not desired because they negatively affect flavor and bioavailability. As one example, degassed oil could be injected into degassed water to create a mixture containing, for example, approximately 100 micron oil droplets for over 3 hours.

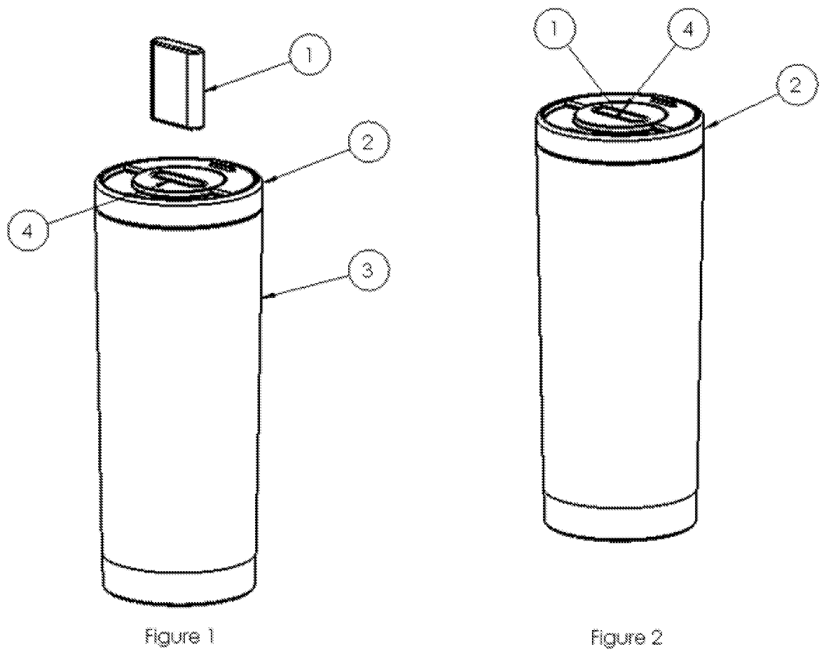

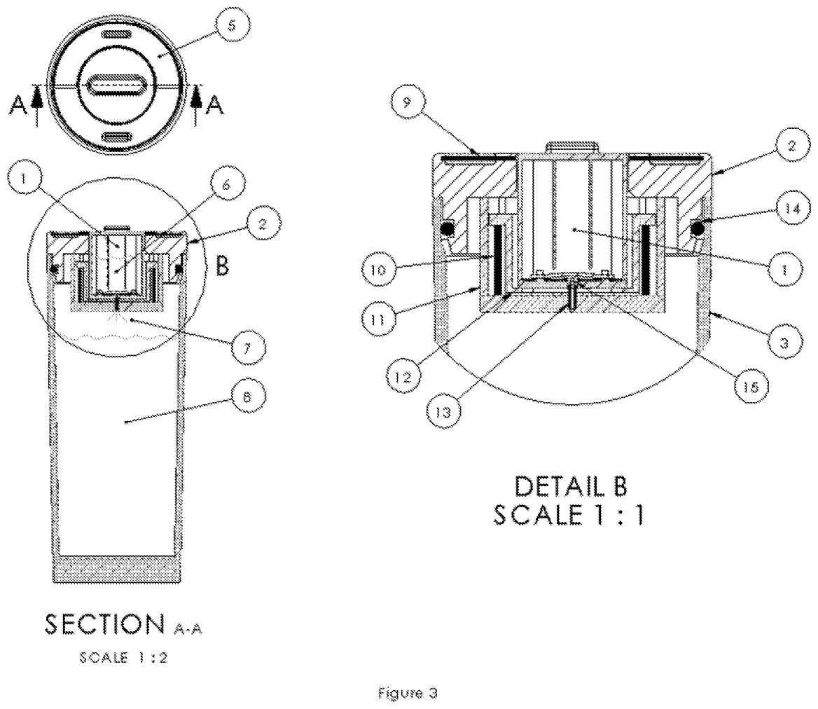

Referring now to FIG. 1-2, FIG. 1-2 illustrates an embodiment of the invention wherein a cartridge (1) contains a gas and flavors and extracts and can be inserted into an opening defined in a cap or lid (e.g., the slot (4) in lid (2) of a container (3)). The opening can be of any suitable configuration and has dimensions that are larger than the exterior dimensions of the cartridge in order to receive the cartridge upon insertion into the opening. In FIG. 1, the cartridge (1) is shown prior to being inserted into the lid (2). In FIG. 2, the cartridge has been inserted into the slot (4) in lid (2). The cartridge (1) and lid (2) are oriented such that the cartridge (1) removably engages the lid (e.g., becomes fully constrained to, the lid (2) when inserted and can be removed by pressing the cartridge (1) downwards which causes a spring mechanism to release the cartridge).

Referring now to FIG. 3, FIG. 3 illustrates an embodiment of the invention wherein the cartridge (1) is filled with a composition to be added to a liquid within the container (e.g., flavor and extracts (6)). The container (3) is filled with a liquid (8) and lid (2) is affixed to the container. When the cartridge (1) is inserted into the lid (2), the flavor and extracts from the cartridge (1) contact the liquid (e.g., flavor/extracts are sprayed (7) onto and the liquid and become dispersed within the liquid (8)). The stream or spray (7) has a relatively high velocity and creates enough disturbance when contacting the liquid (8) to create mixing. A protective cover (5) rotates about an axis (9) to open a spout where one can consume the liquid (8). A housing (11) holds a moveable member (12) which is opposed by compressible members such as springs (10). The moveable member (12) interacts with the cartridge (1) in such a way that the cartridge is removably affixed to the lid (2) when pressed downward once. When pressed downwards a second time, the moveable member (12) moves upwards and both unlocks and presents the cartridge (1) for removal. In this way, cartridges (1) can temporarily become part of the lid (2) but, as and desired, can also be refilled and replaced.

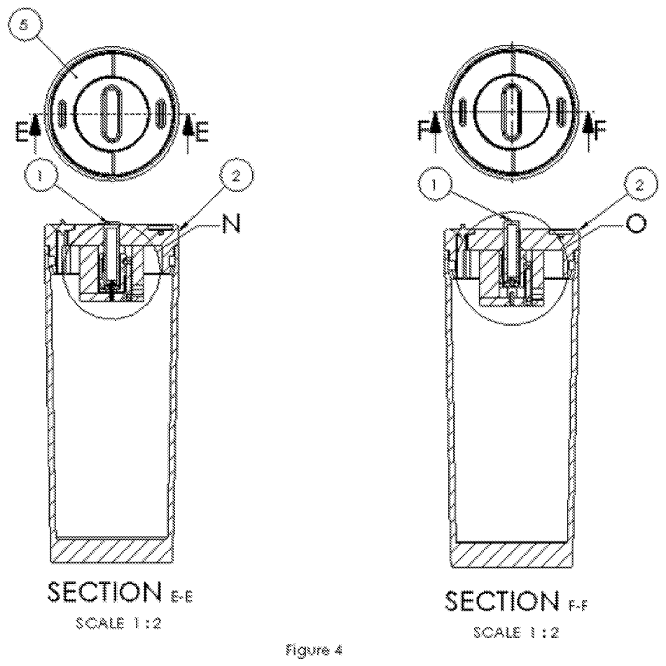

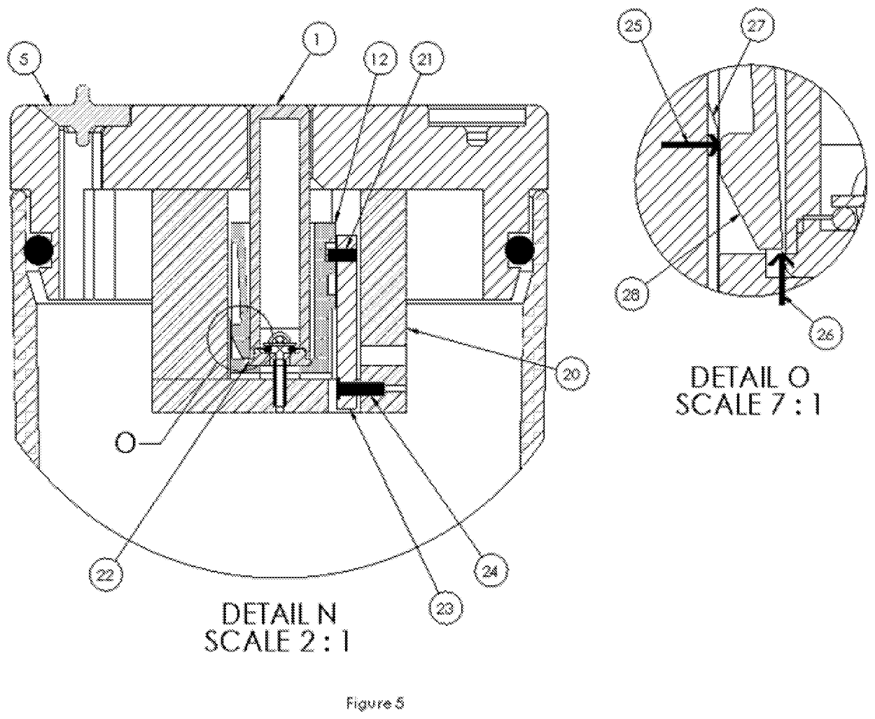

On embodiment of the mechanism is illustrated in FIG. 4-7. A tube (13) presses a valve member (15) in the cartridge (1) upwards which provides a flow path for the flavor and extracts (6) out of the cartridge (1). An o-ring (14) is used to seal and removably affix the lid (2) to the container (3).

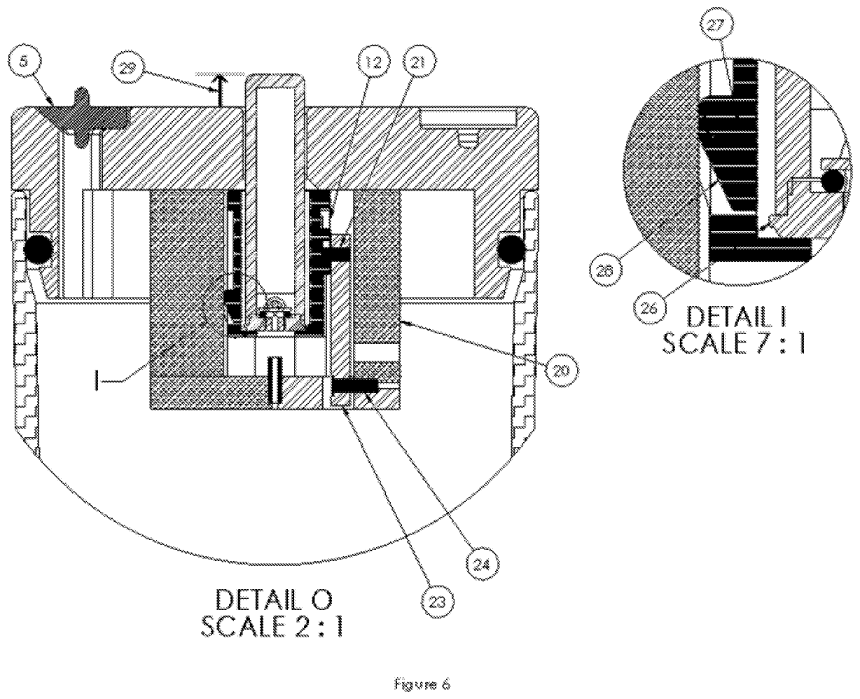

Referring now to FIG. 4, FIG. 4 illustrates an embodiment of the invention wherein the cartridge (1) can be removably locked into a fixed position within or upon the lid (2) by pressing downwards once, and then removed by pressing downwards again. The configuration in Section EE shows the cartridge (1) locked into the lid (2). The configuration in Section FF shows the cartridge (1) presented above the surface of the lid (2) for easy removal. Further detail is shown in FIGS. 5-6.

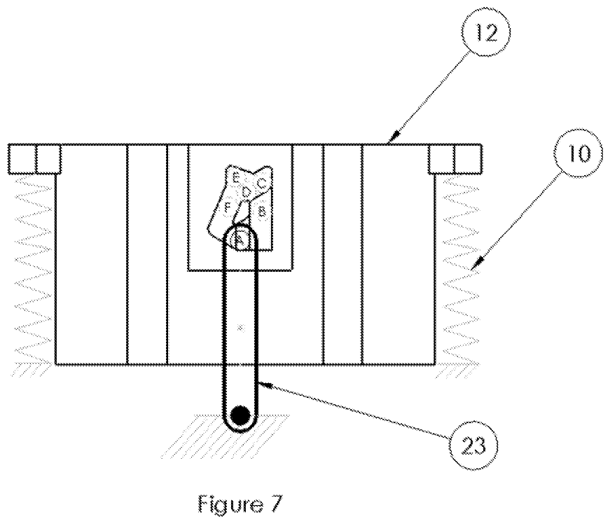

Referring now to FIG. 5, FIG. 5 illustrates an embodiment of the invention wherein the cartridge (1) can be removably affixed to the lid (2). A moveable member (12) is able to move upwards and downwards relative to a fixed body (20). An angular (e.g., wedge) shaped feature (27) on the fixed body (20) causes a compressible (e.g., snap) feature (28) to move towards the right when the moveable member (12) is moved downward relative to the fixed body (20). When the cartridge (1) is inserted into the lid (2), the moveable member (26) is forced to move downward relative to the fixed body (20) which causes the feature (28) to overlap with the rib feature (26) on the cartridge (1). The feature (28) can thereby constrain the cartridge (1) from moving upwards or downwards relative to the moveable member (12). A mechanism comprising an arm (23), a bolt (24), and a pin (21) in conjunction with springs (10, FIG. 3) enables the moveable member (12) to move upwards and downwards between two different positions. The pin (21) follows a groove defined into the moveable member (12). The groove can have any suitable configuration and is defined in such a way to cause the pin to follow counterclockwise closed path with every up/down cycle of the moveable member (12). One example of a configuration of this groove is illustrated further in FIG. 7. The pin (21) is fixed to the arm (23) which is in turn fixed to the fixed body (20) with a bolt (24). The arm (23) is free to rotate about the bolt (24) but is not free to translate its relative position. The moveable member (12) is compressibly biased (e.g., spring loaded), in such a way that it has a continuous upwards force applied. The nature of this mechanism is such that each time the moveable member (12) is pressed downward, the resting position of the moveable member (12) cycles between an up and down position. In this way, the cartridge (1) can be pressed into the lid (2) and will be fixed in a low position until it is pressed again, in which case the springs will push it to the high position, releasing the cartridge (1) from the lid (2). A spout cover (5) is also shown which covers the drinking spout until a user is ready to consume the beverage.

While the invention has been described with reference to a preferred embodiment, it will be understood by those skilled in the art that various changes may be made, and equivalents may be substituted for elements thereof without departing from the scope of the invention. In addition, many modifications may be made to adapt a situation or material to the teachings of the invention without departing from the essential scope thereof. Therefore, it is intended that the invention not be limited to the embodiment disclosed as the best mode contemplated for carrying out this invention, but that the invention will include all embodiments falling within the scope of the appended claims.

1. An apparatus for mixing a fluidizable material with a liquid, the apparatus comprising a pressurized cartridge having a housing that contains material to be fluidized and introduced into the liquid; wherein the cartridge and the housing are positioned to force the contents from the housing into the liquid.

2. The apparatus of claim 1 wherein the fluidizable material comprises an extract.

3. The apparatus of claim 2 wherein the housing defines an orifice that controls the flow of the extract into the liquid.

4. The apparatus of claim 3 wherein the apparatus further comprises an adapter for receiving the housing.

5. The apparatus of claim 4 further comprising an adapter that connects and provides fluid communication between the cartridge, housing and liquid.

6. The apparatus of claim 2 further comprising at least one means that adjusts the flow of extract into the liquid.

7. The apparatus of claim 1 wherein the pressurized cartridge comprises at least one of carbon dioxide and nitrogen.

8. An apparatus for dispensing a liquid comprising a pressurized cartridge having a housing that contains a material to be fluidized and introduced into the liquid; wherein the cartridge and the housing are positioned to force the contents from the housing into the liquid within a bottle wherein the housing controls the flow from the pressurized cartridge through the housing to create the fluidized material and to force the fluidized material downwardly within the liquid thereby causing fluidized material released from the housing to flow upwardly through the liquid in the bottle and in turn dispense the liquid from the bottle.

9. The apparatus of claim 8 wherein the cartridge and housing are removably connected to the bottle.

10. The apparatus of claim 9 further comprising an adapter that connects and provides fluid communication between the cartridge, housing and bottle.

11. The apparatus of claim 8 wherein the fluidized material comprises at least one extract.

12. The apparatus of claim 11 further comprising at least one means that adjusts the flow of extract into the liquid.

13. The apparatus of claim 8 wherein the pressurized material comprises at least one of carbon dioxide and nitrogen.

14. A method for dispensing a beverage using the apparatus of claim 1.

15. The method of claim 14 wherein the fluidized material is mixed with the liquid before dispensing the beverage.
